(19) United States
(12) Patent Application Publication
(10) Pub. No.: US 2007/0122516 A1
(43) Pub. Date: May 31, 2007

(54) Apparatus for preparing fresh ravioli, dumpling and pastries with filling in kitchen

(76) Inventor: Tiangang Qian, Placentia, CA (US)

Correspondence Address: TIANGANG QIAN, 1919 YOUNG DR., PLACENTIA, CA, 92870, US

(21) Appl. No.: 11/164,563

(22) Filed: Nov. 29, 2005

(51) Int. Cl. B29C 47/08

(52) U.S. Cl. 425/200; 425/289

(57) ABSTRACT

An apparatus to mix, extrude, shape, and cut an outer layer of viscous material about the core of another material, especially for preparing fresh ravioli, dumpling and similar pastry in kitchen. The apparatus includes two co-centric containers for holding materials, a mixing assembly for preparing the materials, an extrusion system wrapping core material inside the viscous outer layer, and a shaping and cutting assembly to form desired food units whether its ravioli, dumplings or other shapes. The container for core materials is removable and enclosed inside the container for outer layer materials. The mixing assembly for both core materials and outer layer materials comprises of a plurality of mixing and scraping blades attached to the spinning cylinder which is mounted in between outer container and inner container and to a centrally located tube inside the inner container, the centrally located tube is mounted on an inner lid which is securely caped on the spinning cylinder. And an extrusion system comprising of extrusion screw and dies, is mounted under the bottom of the outer container, through which contents of the outer container are extruded into desired tube-shaped outer layer and core materials are fed in a shape of continuous cylindrical link inside the outer layer before they are fed into the cutting roller. The shaping and cutting assembly comprises of two rollers where at least one roller is engraved for the desired shape and cut of food units. A single drive means rotates a main shaft that in turn drives rollers, turns spinning cylinder and the attached mixing and scraping blades, and turns extrusion screw. The extrusion screw, dies, the spinning cylinder and the inner container for core materials are removable from the apparatus for easy cleaning.

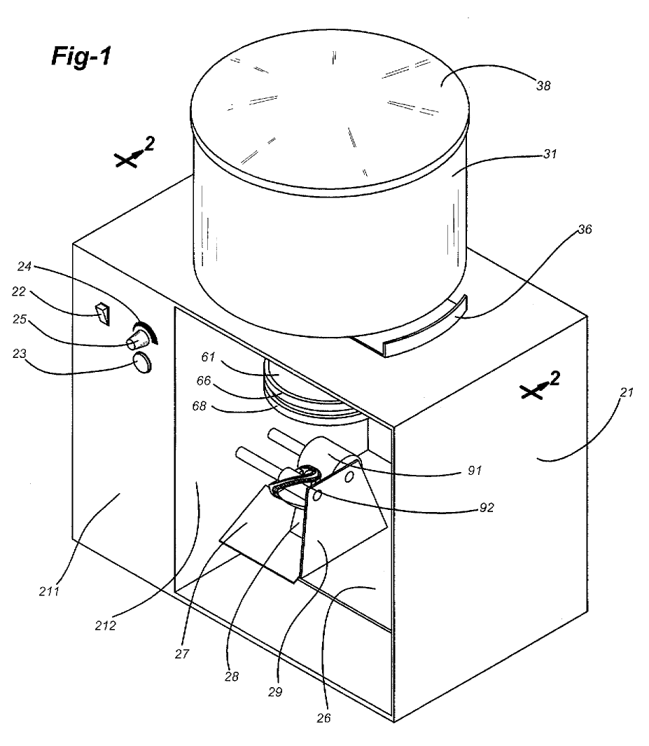

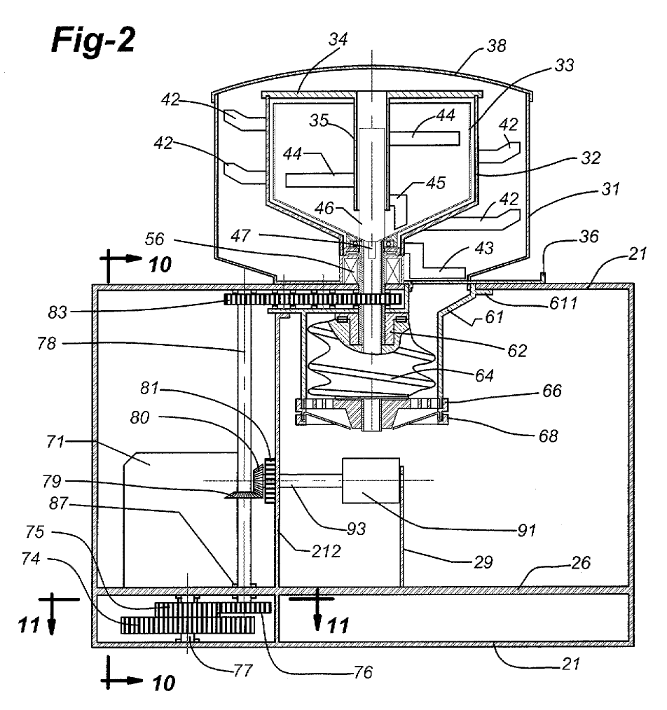

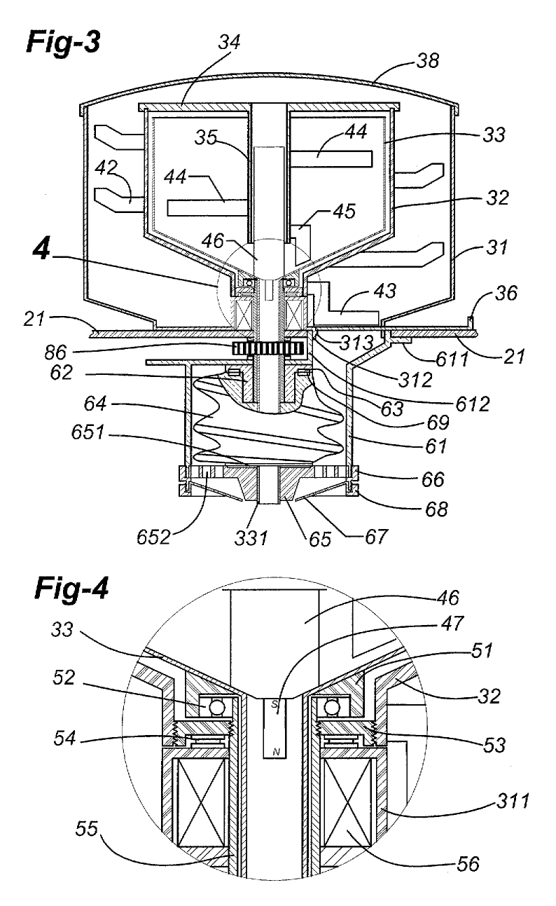

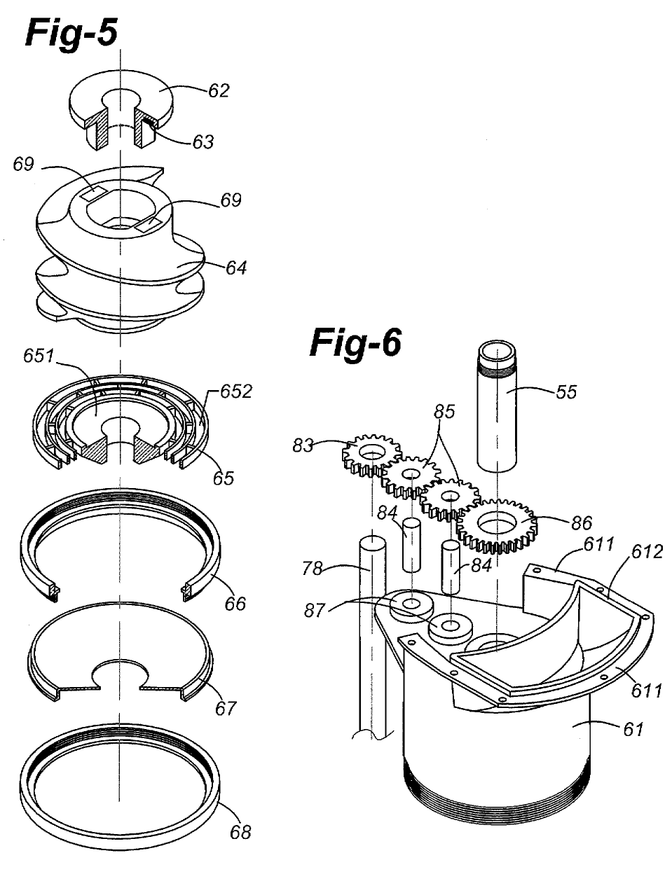

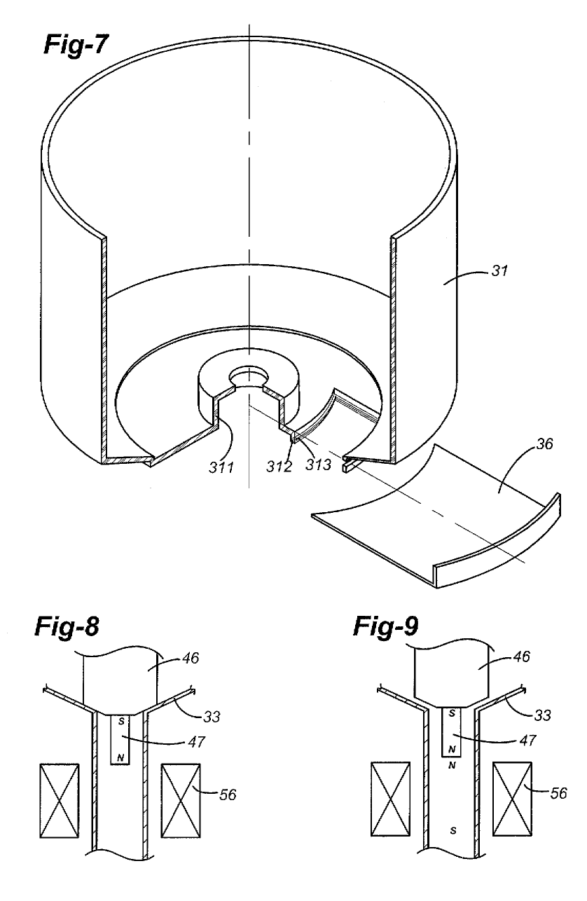

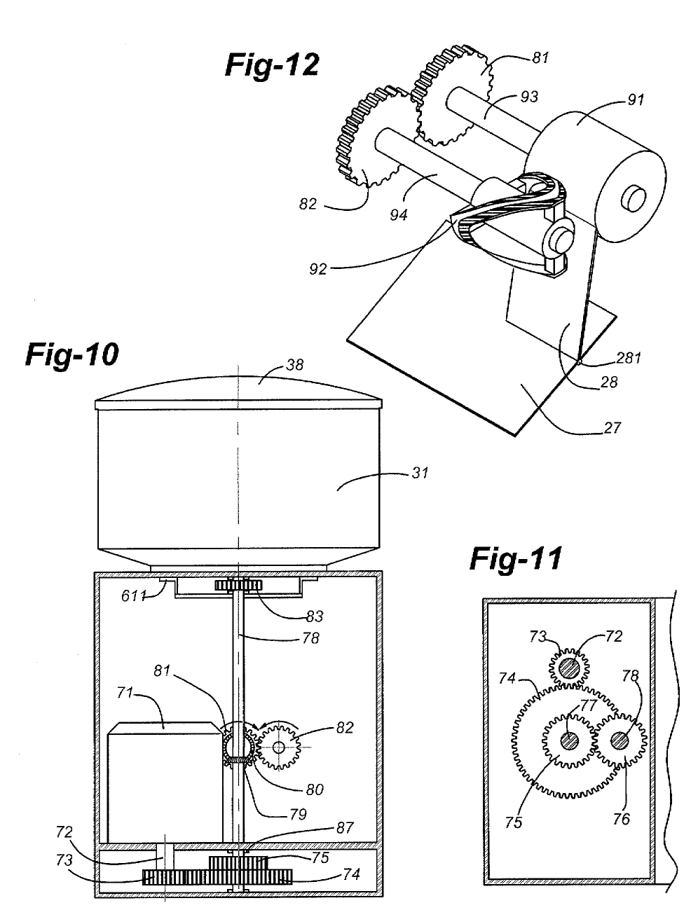

### FIELD OF INVENTION

This invention relates to an apparatus used for the preparation of food articles where an outer layer of viscous material envelops the core of another material in particular to a device for the mixing, extrusion, shaping and cutting of food condiments.

### DESCRIPTION OF PREVIOUS ART

All previous inventions and devices in the market related to continuously mass making an outer layer of viscous material about the core of another material apparatus share the following characteristics:
1. Chambers and containers mixing different materials are physically situated apart from each other.
2. Use of rollers or conveyors to transport the made dough.
   Such characteristics have a number of flaws: the structure results in a machine that is very space occupying and not fit for household or small restaurant use, many are complicated to use and inconvenient to clean. Two typical examples are U.S. Pat. No. 4,636,158 and U.S. Pat. No. 3,615,147, those two inventions have better unique structure and the apparatus could occupy less space than other's. However, the apparatus for molding an outer layer of viscous material about a core of another material uses two separate chambers: one for the viscous material and another for the core the material in each chamber are then transported together. And a previously made outer layer material such as dough is required thus giving the user extra work. The inventions mentioned still fails to solve the problem of space efficiency, and these machines are still too complicated to run and difficult to clean for kitchen or restaurant use.

### SUMMARY OF INVENTION

This invention uses the concept of “chamber in chamber” to make the machine smaller and more space efficient for use in the home or small restaurants. This design also allows for easy use and is convenient to clean making it very practical for household use. The apparatus is easily assembled and requires little input from the user. It takes raw materials, mixes, kneads, extrudes, shapes and cuts the food condiments preparing them to be cooked right away or stored for later use. The machine saves time, space, and money for those who enjoy homemade foods with fillings such as ravioli, dumplings, or various types of pastries. The preferred embodiment of the apparatus consists of an inner chamber situated inside a spin-able chamber where the spin-able chamber is enclosed by the outer chamber. The viscous outer material is mixed and kneaded in the outer chamber while the core material is mixed inside the inner chamber. Condiments inside each chamber are mixed by blades extending from the spin-able chamber which is powered by a motor in the machine. Once materials are ready to be extruded, the bottoms of the chambers are opened and materials are moved down to an extrusion chamber where the viscous material is further kneaded and shaped into a tube by extrusion die. The extrusion of core material is controlled by an adjustable stopper and the bottom of the inner chamber. Viscous material is extruded from extrusion chamber as a tube about a rope of core material. The materials are ran through two adjacent rollers turning towards each other where one roller is shaped to cut the material while the other roller acts as cutting surface.

The apparatus functions using one power source. The gears, rollers, spinning-chamber and all other movement are powered by one motor thus making the apparatus very efficient and user-friendly.

### DESCRIPTION OF DRAWINGS

FIG.-1 is a perspective view of preferred embodiment of the present invention.

FIG.-2 is a vertical cross section view through the center of the embodiment taken along line 2-2 of FIG.-1.

FIG.-3 is a partial enlarged vertical cross section view through the center of the inner chamber, spin-able chamber, outer chamber and extrusion chamber from FIG.-2.

FIG.-4 is a partial enlarged view of area -4 in FIG.-3.

FIG.-5 is a fragmentary, exploded perspective view of the pieces of the extrusion system.

FIG.-6 is an exploded perspective view of extrusion chamber and related gears and shafts.

FIG.-7 is a fragmentary, exploded perspective view of outer chamber and separate gate.

FIG.-8 is a demonstration of stopper at closing status.

FIG.-9 is a demonstration of stopper at opening status while permanent magnet is repelled by electromagnet.

FIG.-10 is a vertical cross section view taken along line 10-10 of FIG.-2.

FIG.-11 is a partial horizontal cross section view taken along line 11-11 of FIG.-2.

FIG.-12 is an exploded perspective view of roller cutters and related shafts and gears.

### DETAIL DESCRIPTION OF PREFERRED EMBODIMENT

FIG.-1 shows the perspective view of the preferred embodiment of the present invention. The embodiment is basically comprises 4 systems, a base cabinet 21, a mixing and feeding system enclosed in lid 38 and chamber 31 which is mounted on the top shelf of cabinet 21, an extrusion system mounted under beneath the top shelf of cabinet 21 and the extrusion chamber 61 is connected or disconnected to chamber 31 by opening or closing gate 36, a roller cutting system mounted on the shelf 26 directly under the extrusion system and a power transmission system is hide inside of walls 211 and 212 of cabinet 21. An on-off switch mounted on the wall 211 controls main power of mixing, feeding, extrusion and cutting. A button switch 23 is for power supply to the electromagnet 56 as shown in FIG.-2, and a related turning knob 25 above switch 23 controls electric current intensity inputting to the electromagnet. Mark 24 shows the direction of increasing or decreasing of current intensity.

Referring to FIG.-2 and FIG.-3, the present invention concept of “chamber in chamber” for mixing and feeding system is revealed: smaller chambers being enclosed inside of larger chamber. The spin-able chamber 32 is enclosed by a larger mixing chamber 31; the spin-able chamber 32 encases inner funnel- shape chamber 33 where filling ingredients are mixed together. Blades 42 and 43 are attached to the exterior of spin-able chamber 32 so that when chamber 32 is rotated via shaft 55, the blades move along with the chamber 32 and mix the ingredients in chamber 31 making a viscous material. Chamber 31 is covered by lid 38 and chamber 32 is covered by inner lid 34. Lid 34 is secured to chamber 32 but not chamber 33. A cylindrical tube 35 attached to lid 34 runs through the center of chamber 32 and blades 44 and 45 are attached on tube 35, so when chamber 32 is rotated, lid 34, tube 35, and stirring blades 44 and 45 also rotates mixing the ingredients sitting in a stationary chamber 33. Rod 46 runs through tube 35 and has a cone shaped head which fits the bottom opening of chamber 33 serving as a stopper.

Referring to FIG.-3, FIG.-4, FIG.-8 and FIG.-9, an electromagnet 56 is mounted between the underneath housing 311 of chamber 31 and the top shelf of cabinet 21 along the center line of shaft 55. The amount and speed which condiments travel through chamber33 into tube 331 is adjusted by controlling the gap between the stopper 46 and the bottom of chamber 33. FIG.-8 shows stopper 46 is in closing status by gravity while the electromagnet 56 is in off status. FIG.-9 shows the status that the electromagnet 56 is on and is generating opposite magnetic field against permanent 47 and the magnet 47 is pushed up by the opposite magnetic field from electromagnet 56, then the stopper 46 along with magnet 47 is pushed up, and allows the ingredients in chamber 33 pass over the stopper 46 and into the tube 331 which is attached underneath the bottom of chamber 33. Referring to FIG.-1, by pushing the button switch 23, the electromagnet 56 will be on, by turning switch 25, the electric current inputted to electromagnet 56 adjusted, the greater the electric current, the stronger the electromagnet, and the stopper 46 will be pushed higher, then more ingredients flow into tube 331; in the opposite way, the same reason, the weaker the electric current, lower the stopper 46 to be pushed and the less ingredients flow into tube 331.

Chamber 32 and the parts attached to it are rotated while the inner chamber 33 inside chamber 32 remains still due to the placement of bearing 52. Chamber 33 is secured to seat 51, where seat 51 is tightly secured to the outer diameter of bearing 52. Chamber 32 is screwed to a special shaped screw 53 which both sits on a needle roller bearing 54 and is securely screwed on shaft 55, and the upper part of shaft 55 is then tightly secured to the inner diameter of bearing 52. Thus when shaft 55 is rotated, the attached chamber 32 and inner diameter of bearing 52 also rotates while seat 51, which as tightly fitted to the outer diameter of said bearing 52, remains stationary, and therefore chamber 33 which is sitting on seat 51 also remains stationary.

Referring to FIG.-3, FIG.-6 and FIG.-7, the bottom opening 312 of chamber 21 gets through the top shelf of cabinet 21 and directly connected with the upper lip 612 of extrusion chamber 61. Gate 36 separates the ingredients in chamber 31 from the extrusion chamber 61. Gate 36 can slide in for closing or out for opening along edge 313 surrounding the inside wall of opening 312. Gate 36 is opened once the dough ingredients have been sufficiently mixed and is ready to be extruded. Once gate 36 is opened, the scraping blade 43 will push the dough down to chamber 61, and then dough is to be guided down by extrusion screw 64 which is secured to rotating shaft 52 by a sleeve clutch 62. Gear 86 turns shaft 52 which turns attached clutch 62 causing extrusion screw 64 to turn and push the dough downward. A seat 651 in multi-layer extrusion die 65 is attached to the bottom of extrusion screw 64, the die 65 is held by a threaded holding nut 66. On the inside of upper part of nut 66 it is female threaded to match male threads on the outside of bottom part of extrusion chamber 61, the middle part of nut 66 is a flat ring edge to hold die 65, the inside of bottom part of nut 66 is a seat to fit shaping die 67 and the out side of bottom part of nut 66 has male threads to fit with female threads on the inside of holding nut 68. Dough is driven down by extrusion screw 64 and passes through the multi-layer hollow in die 65, then meets with the inner wall of shaping die 67, the dough is squeezed between the outer wall of the lower part of die 65 and the inner wall of die 67 to be shaped into tube-shape. The thickness of the dough tube is adjusted by screwing holding nut 68 closer or further away from nut 66, moving nut 68 further down moves down the shaping die 67 leaving a bigger gap for dough to be extruded, moving nut 68 up moves the shaping die up reducing the gap through which the dough is extruded making the dough tube thinner. Screw 64 is attached to the upper flat edge of clutch 62 by magnet 63 and magnet 69, magnet 63 and 69 are installed separately on clutch 62 and screw 64 and their magnetic orientation is arranged in the way of being attractive each other. Referring to FIG.-5, The inside of upper part of screw 64 has vertical flat and circle walls that are matched with the outer lower part of clutch 62, which helps the screw 64 not slipping while turning. The Screw 64 can be easily detached and removed for cleaning by unscrewing nut 66 and detaching from magnetic clutch 62 by pulling downward.

Referring to FIG.-10 and FIG.-12, adjacent rollers 91 and 92 situated directly beneath extrusion chamber 61 roll toward each other. The two rollers have the same dimensions however roller 91 serves as the cutting surface therefore has a smooth surface while 92 acts as cutting die and thus surface of 92 is engraved with desired shape. The two adjacent rollers rotate toward each other shaping and cutting the extruded condiments sealing the core material with the outer layer of viscous material. Ramp 27 is situated directly beneath the rollers to transport the finished food articles out of the machine. Ramp 27 consists of a tilted board at an angle that made food articles are gently guided down and out of the machine. On the middle part of ramp 27, a metal scraping board 28 is attached through link with spring hinge 281. The hinge 281 applies a spring pressure pushing 28 against the cutting surface on roller 91 thus when rollers are running, all viscous material is properly cut and scrapped off of the cutting surface for transport onto ramp 27. Scraping board 28 comprises of a thin sheet of metal ensuring that no viscous material remains attached to roller 91 after cutting. Rollers 91 and 92 are held up by shaft 93 and 94 whose one side is held by wall 212 and the other side is held by stands 29 as shown in FIG.-1.

The apparatus has a drive means which includes a drive motor 71 in the bottom corner of the cabinet 21. The motor turns shaft 72, which turns attached first gear 73, then the first gear 73 drives second gear 74 simultaneously turning third gear 75 for both of them are attached to same shaft 77. Third gear 75 in turn drives forth gear 76 which turns main drive shaft 78. Shaft 78 drives a fifth gear 79 that then drives a perpendicular sixth gear 80. Gear 80 turns vertically therefore turning horizontal shaft 93 simultaneously turning a seventh gear 81, then gear 81 drives the eighth gear 82 which turns shaft 94. Shaft 93 turns roller 91 and shaft 94 turns roller 92. This design causes the two rollers to turn toward each other. The ninth gear 83 is attached to the top of main shaft 78 therefore turns with the shaft and in turn driving gears 85 which are attached to shafts 84. Gears 85 drive the main gear 86 attached to shaft 55 therefore turning shaft 55. Shaft 55 is secured to chamber 32 through a special screw 53 thus the powering of gears 86 causes the rotation of chamber 32 with all interior and exterior attached mixing and scraping blades and the rolling of rollers 91 and 92. The bottom of shaft 55 is secured to extrusion screw 64 by sleeve clutch 62 causing extrusion screw 64 to turn with shaft 55.

All gears are enclosed in the cabinet to reduce the hazard and for visual appeal. All devices and mechanisms under the mixing chambers are protected by a cover, an door shall be mounted in the opening front of cabinet 21 to make the roller cutting system to be protected and the door shall be closed make the machine safer to user while running the machine, except ramp 27 where finished food exits the machine.

The described embodiment may be constructed using various materials or a combination of various materials and methods known to those knowledgeable in the art.

The embodiment may be constructed at any useful scale. For example, the chambers can be made in various sizes depending on the size of the scale of production.

What has been described herein is an embodiment of the present invention. This description is presented as an illustration and an aid in understanding the present invention and in no way is intended to limit the scope of the present invention which is described by the claims contained herein. One knowledgeable in the art would readily recognize that many variations are possible without departing from the invention's basic concepts.

What is claimed is:

1. Apparatus for preparation of an outer layer of viscous material about the core of another material comprising of:
a) An mixing and feeding system with at least one inner chamber for core materials and at least one outer chamber for outer layer materials, vertically mounted using “chamber in chamber” structure; and said “chamber in chamber” structure means smaller chamber is situated inside the larger chamber; and
b) A downward-cone-shaped or spherical stopper, a permanent magnet vertically mounted under said stopper, coupled with an electromagnet to open or close said stopper controlling the amount and speed at which core materials run through the said inner chamber; and
c) An extrusion chamber containing at least one clutch and at least one extrusion screw vertically mounted under said outer chamber; and
d) A roller cutting system containing two adjacent rollers rolling towards one another where at least one roller is engraved with the desired shape serving as the cutter roller; and
e) A base cabinet where said outer chamber, said extrusion chamber, said roller cutting system and driving power system are mounted on or in.

2. An apparatus as claimed in claim 1, wherein:
an spin-able chamber sits in between said inner chamber and outer chamber, and said inner chamber and said spin-able chamber are both removable.

3. An apparatus as claimed in claim 2, wherein:
said inner chamber is completely enclosed in said spin-able chamber, and said spin-able chamber is completely enclosed by said outer chamber.

4. An apparatus as claimed in claim 3, wherein:
the wall of said inner chamber is parallel and side-by-side but not touching to the wall of said spin-able chamber so when said spin-able chamber rotates, said inner chamber remains stationary; and said outer chamber is fixed stationary on the top of said base cabinet.

5. An apparatus as claimed in claim 1, wherein:
said outer chamber leads through to the top of said base cabinet and can be directly connected with said extrusion chamber.

6. An apparatus as claimed in claim 1, wherein:
said outer chamber, can either be separated from or directly connected to said extrusion chamber by a horizontal gate acting as a part of the base of said outer chamber and the top of said extrusion chamber when shut.

7. An apparatus as claimed in claim 1, wherein:
said clutch inside said extrusion chamber has at least but not limited to one permanent magnet, and said extrusion screw contains at least but not limited to one piece of magnetic metal or magnet. Said extrusion screw is held up on said clutch magnetically and supported by holding seat on an extrusion die to which the said extrusion screw is attached to the base of extrusion chamber.

8. An apparatus as claimed in claim 7, wherein:
said extrusion die consists of many small openings arranged in multi-layer fashion that allows for further kneading of viscous material when material screwed through.

9. An apparatus as claimed in claim 7, wherein:
said extrusion screw that is attached magnetically to said clutch inside said extrusion chamber can be easily detached for removal.

10. An apparatus as claimed in claim 2, wherein:
said spin-able chamber rotates with motor while said inner chamber remains stationary through a bearing at the base of said spin-able chamber wherein said inner chamber sits on a seat which is attached to the outer diameter of said bearing.

11. An apparatus as claimed in claim 10, wherein:
said spin-able chamber is secured to a shaft attached to the inner diameter of said bearing while said inner chamber is sat on said seat attached to the outer diameter of said bearing.

12. An apparatus as claimed in claim 2, wherein:
said spin-able chamber has multiple blade extensions into the exterior chamber where a minimum of one blade serves as a scraping blade and multiple blades serve as mixing blades for the condiments in said outer chamber.

13. An apparatus as claimed in claim 12, wherein:
a tube which, attached to an inner chamber lid secured on the top of said spin-able chamber, runs down the center of said inner chamber; and
said tube has a minimum of one scraping blade extension and multiple mixing blade extensions where extensions reach into the space inside said inner chamber.

14. An apparatus as claimed in claim 13, wherein:
said spin-able chamber with blade extensions and said tube with blade extensions inside inner chamber is all simultaneously rotated using one motor.

15. An apparatus as claimed in claim 1, wherein:
said stopper staying closed on the bottom of said inner chamber by gravity or by attraction force between said permanent magnet and said electromagnet; and said stopper is lifted above the bottom of said inner chamber by turning on a repelling force between said permanent magnet and said electromagnet.

16. An apparatus as claimed in claim 15, wherein:
the gap between said stopper and the bottom of said inner chamber is adjusted by controlling the voltage or the electric current running to said electromagnet.

17. An apparatus as claimed in claim 1, wherein:
driving power for mixing, feeding, extrusion and cutting is from the same single motor.
